(19) United States
(12) Patent Application Publication
(10) Pub. No.: US 2006/0185222 A1
(43) Pub. Date: Aug. 24, 2006

(54) Removably engageable guides for fish line stripping

(76) Inventor: John M. Alvarez, Oceanside, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/360,360

(22) Filed: Feb. 23, 2006

Related U.S. Application Data
(60) Provisional application No. 60/655,771, filed on Feb. 23, 2005.

(51) Int. Cl. A01K 97/00; A01K 97/06

(52) U.S. Cl. 43/54.1; 43/4

(57) ABSTRACT

A fish line guide device formed by a plurality of removably engageable guide members forming a serpentine fish line path. The guide members can be engaged to a surface of a basket worn by an angler or to the surface on which the angler is standing such as a boat deck. Engagement is accomplished by base mounts which engage with the base end of the guide members and hold the guide member substantially perpendicular from the surface. A sandwiched engagement of the guide member and base mount or a suctional engagement of the base mount to a surface, or a tongue and groove style engagement provides the projecting mount of the guide members to the surface. The guide members may also be engaged to a flexible surface layer which is then supported upon a support surface adjacent to an angler.

### BACKGROUND OF THE INVENTION

This application claims the benefit of U.S. Provisional Patent Application No. 60/655,771 filed Feb. 02, 2005.

### FIELD OF THE INVENTION

The present invention relates to fishing. More particularly it relates to a device that minimizes the tangling of fishing line used during fly fishing. The device employs removably attachable members that are removably engageable to one or a plurality of baskets, or platforms that can be made and worn by anglers during fly fishing, or optionally can be mounted on any relatively smooth surface adjacent to the angler if a support platform is not being worn or if a ground position is preferred.

### PRIOR ART

Casting a line during fly-fishing is an art engaged in by millions of anglers worldwide. The skill to accurately cast the line is developed over time and with great amounts of practice. Typically, during a casting session, the angler strips line from a reel and allows the line to fall to the ground or into the water. This provides the angler with a predetermined amount of line which can be cast on the water with a fly or other delicate morsel attached at the distal end so as to entice a fish to strike.

In stripping the length of line from the reel and depositing it in layers adjacent to the angler the line is generally placed temporarily in a number of places adjacent to the angler, such as in the water, on land next to the water, on a boat dock, or on a boat deck. During the angler's placement of the unwound line on top of or overlapping itself, a tangled line is very often the result. The potential for tangles increases with the onset of a blowing wind or the presence of any other impairments which inherently snare the line such as rocks, grass, branches, stumps, dock snags, and even the angler's feet.

Tangled lines result in frustration and lost fish due to the time needed to rectify the problem. Additionally, the distance cast and the accuracy of the cast are affected by a plurality of different factors. Depositing the line directly on the ground in addition to facilitating tangling will inherently cause dirt and debris to stick to a wet line increasing line weight and decreasing distance and accuracy of the cast.

Further, the total distance of the cast is also decreased in direct proportion to the distance the fly line is located from the rod during a cast. Consequently, it is in the interest of the angler to keep the stripped line as close as possible in proximity to the rod to increase the potential total distance of the resulting cast.

A conventional device to help alleviate the problems resulting from stripping the fishing line and depositing it adjacent to the angler is the stripping basket. Such baskets are generally worn on the front of the body of the angler and are supported around their waist by a belt. Some baskets are homemade, employing anything from a dishpan to a trash can and a belt. Others are custom made and employ canvas-like fabric.

Unfortunately, such baskets frequently are dimensionally cramped and do not provide for easy placement of the line in the basket portion. Further, the baskets, while proximately closer to the rod than the ground, still tend to cause tangles in the line deposited therein. Also, there are venues where a basket is not especially convenient to use such as on a boat deck when fly fishing in the ocean. Still further, fishing is a sport of skill and customized techniques and conventional baskets and line supports and separators do not allow the fisherman themselves to form various pathways for line separation while in the basket or on the ground or some other line support device.

As such, there exists a continuing unmet need for a device that will easily engage to a chosen platform of the angler whether it be a mat, some type of worn platform such as a stripping basket or planar mount, or a boat deck to form a customizable plurality of pathways for dropped line to eliminate or at least minimize tangles. Such a device should be easy to attach to any type of surface or platform or basket, be it a plastic dishpan, a smooth or rough ground mat, a fabric pouch, or a boat deck. Such a device should allow for maximum customization by the angler since fishing is a sport of skill. Such a device in the case of a flexible fabric basket or mat should also minimize the amount of space the basket takes when stored by minimizing the size of the device when engaged, or it should be removable to allow for folding of the basket. Still further, such a device should be engageable not only to a platform such as a bag or basket worn by the angler but also to mats located on the ground surface adjacent to the angler or directly to a boat deck or smooth support surface, in the event that a worn mounting platform is not practical.

### SUMMARY OF THE INVENTION

The device and method herein disclosed and described achieves the above-mentioned goals through the provision of a removable mounting system employing a plurality of elongated guide members adapted to engage through or onto a planar surface located in front of or adjacent to the angler. The surface can either be in the bottom of a planer platform or basket made from rigid or stiffened flexible material or any relatively smooth surface located adjacent to the feet of the angler such as a boat deck if the angler is fly-fishing in the ocean or on a lake. By employing a plurality of the members with each having a lower end adapted for a mount to the chosen platform, the angler is able to form customized torturous pathways for dropped line to fall into and remain untangled during any fishing session.

The device as shown and disclosed herein is highly customizable using a plurality of elongated guide members with a base or mounting end adapted for engagement to a support platform using the appropriate means for engagement of the base end to the platform chosen. Such means for engagement can be varied and in one favored embodiment adapted for engagement through a pierceable support platform would be provided by a pin adapted to pierce or puncture the support platform and frictionally engage in a cavity axially located at the base end of the guide member. This engagement may be frictional or threadable engagement of the projection rising from a base mount into the cavity the guide member. In cases where the angler is forming the desired line pathways using the guide members and a support platform made from materials on hand it is desirable that the distal end of the projecting pin is shaped to spear through the chosen mounting surface or self-tap through the surface for a mounting into the cavity of the guide member. In this fashion, the angler can form the device using a dishpan, a basket, a rigid platform or some other desired base for the plurality of guide members to mount and form the desired plurality of pathways for the fishing line. In a pinch, the angler could even use cardboard from a box to form the base for the plurality of guide members. While currently for this mode of the device the guide member uses a base mount with a projection, those skilled in the art will realize that other means to achieve a user employable mount to a base can be used and all are such anticipated.

In an operative mount to the chosen surface as noted above, the guide members are operatively engaged in the desired pattern and spacing for the user to obtain a highly customizable device with highly customizable pathways by placing the guide members into mounted positions to yield such. In the current preferred embodiment where a pierceable base member is employed for the mounting surface, mounting is provided by sandwiching that surface in between the guide member and the engaging base mount. An aperture is formed through the mounting surface to allow for this engagement. While this aperture can be formed with a tool, employing a pointed pin allows for the device to be self-piercing during formation. A sandwiched engagement with the mounting surface is thus achieved with the guide members extending substantially perpendicular to the top of the mounting surface to provide the plurality of pathways for line to be deposited.

In another favored mode of the device yielding an especially sturdy mount of the guide member, a mating base component shown as a circular planar ring area may optionally be attached to the base end of the guide member and provide additional vertical support to the guide member when the base is sandwiched between it and the base mount on the bottom surface.

As noted above, the base surface may either be a planar pierceable surface that can be placed adjacent to the angler, or could be worn by the angler if attached to a belt or some other type of engagement to their person. If placed on the ground, a flexible mat of rubber or plastic works well; however, even cardboard will work in a pinch, and if the cardboard is plastic coated such as in boxes used for produce, such a base material can work quite well.

In cases where a basket or angler-mounted surface is not employed by the angler, the multiple pathways can be formed by the plurality of guide members placed on any smooth surface adjacent to the angler such as a boat deck by employing that smooth surface as the mounting surface. The base or mounting end of the guide members would be adapted for a suction or other temporary adhesion to the smooth surface adjacent to the angler and this would work especially well on boat decks where the separate mounting surface or a mat might not be the best mode. The serpentine pathways for the stripped line in this mode of the device is still highly customizable to the angler's skill or taste and are formed between the plurality of guide members which are suction-mounted to the boat deck or other smooth surface forming the mounting surface. A smooth surface capable of suctioned attachment can be substituted on dry land if the user wishes to form the pathways using suction cup-enabled guide members.

In an especially useful mode of the device, it can be provided in a kit form, wherein the base end of the guide members is adapted to engage either suction cups or a mating base component in a pierced engagement to the surface below. This kit form would allow the user to configure the guide members to the task at hand for suctioned or pierced mounting, and then form the customized pathways for line therebetween by engaging the plurality of guide members to the chosen surface to yield the desired pathways.

While the substantially cylindrical shape of the guide members is preferred because of the narrow width of the guide members for easy and more compact storage, other shapes may be employed such as frusto-conical or a cone or pyramid shape. Shapes with bigger base ends would provide more lateral support to prevent tipping if desired.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of this invention to provide an improved device configurable by the user to prevent fish line tangling during stripping.

It is another object of this invention to provide such a device to prevent tangling which is engageable through the surface of a conventional fabric or plastic stripping basket.

A further object of this invention is the provision of a stripping guide for fish line that is engageable to a hard surface adjacent to the angler using a suction mount.

Yet another object of this invention is the provision of a fish line guide system which provides plurality of mounts to adapt the elongated members to a suction mount or compressed mount on an angler-worn basket.

A still further object of this invention is the provision of such a fish line tangling prevention device that is highly customizable by the individual user in a sport which values such.

Further objects of the invention will be brought out in the following part of the specification, wherein detailed description is for the purpose of fully disclosing the invention without placing limitations thereon.

### BRIEF DESCRIPTION OF DRAWING FIGURES

FIG. 1 depicts a single guide member and frictionally engageable base mount.

FIG. 2 depicts an embodiment of a single guide member with a threadably engageable base mount and also shows a telescopic version of the guide member that collapses for better storage.

FIG. 2a is an end view of the guide member showing a preferred embodiment with an axial cavity at the bottom end of the guide member to engage with the base mount.

FIG. 3 depicts an embodiment of the device showing the guide member and base mount and a fabric or substantially rigid but pierceable surface that would be sandwiched therebetween.

FIG. 4 shows a side view of the guide member engaged with the base mount and sandwiching the mounting surface therebetween.

FIG. 5 shows another preferred embodiment of the device wherein the guide member engages with a base mount that is adapted for engagement with a suction cup.

FIG. 6 shows a plurality of guide members extending from the top side of a mounting surface and engaged with base mounts on the bottom end of the mounting surface.

FIG. 7 depicts a plurality of the guide members engaged through the a bottom planar surface of a basket which is then employed to hold stripped line.

FIG. 8 depicts a plurality of the removably mountable guide members operatively engaged with suction cup base mounts to a smooth adjacent surface such as a boat deck or smooth mat.

FIG. 9. depicts another embodiment of the removably mountable guide member with a wider base end than the distal end.

FIG. 10 shows another preferred embodiment of the device wherein the guide members are in a pierced engagement with a flexible surface layer which can be placed on the ground or a boat deck which serves as a support surface.

FIG. 11 depicts another mode of the device wherein the top surface of the base is formed to engage a cooperating bottom surface attached to the base of the guide member in removable engagement to the base.

### DETAILED DESCRIPTION OF THE PREFERRED EMBODIMENTS OF THE INVENTION

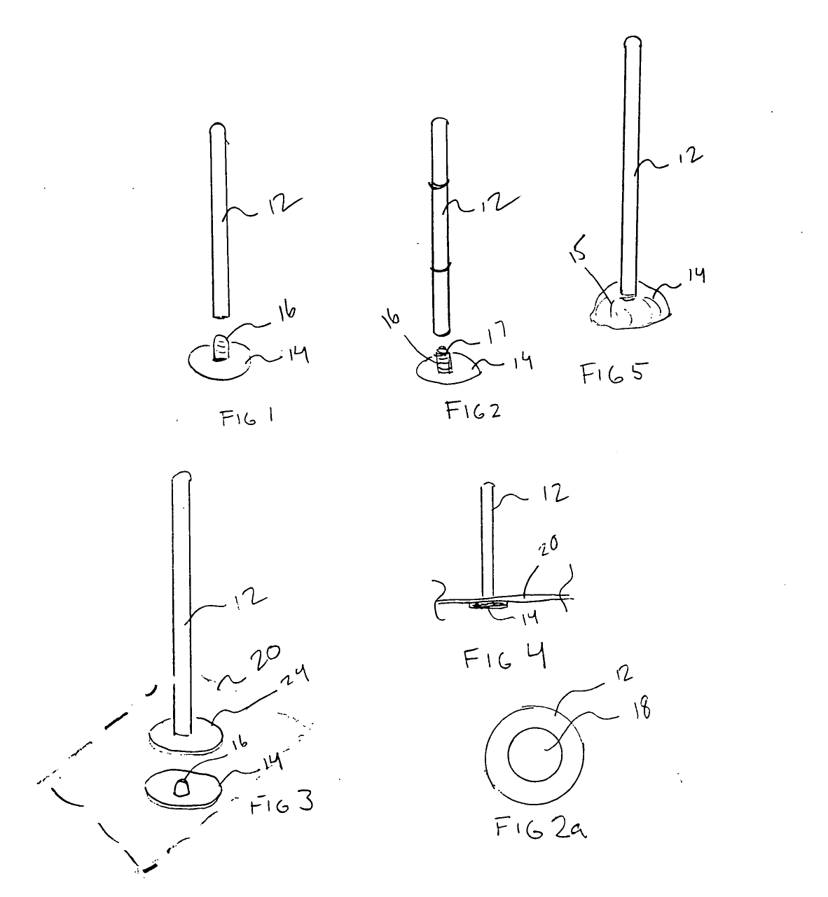

Referring now to the drawings of FIGS. 1-11, depicting the preferred embodiments of the disclosed device 10, FIG. 1 shows a single guide member 12 which is elongated and in the preferred mode has a rounded tip at the distal end of the guide member 12. The base end of the guide member 12 is engageable with a base mount 14 using means for engagement of the base end to the guide member. This means for engagement can be provided by a pin 16 frictionally engageable in a cavity 18 axially located at the base end of the guide member 12. It can also be provided by a threadable engagement of the base mount 14 into the cavity 18 of the guide member 12 as depicted in FIG. 2 where threads 17 are formed on the outside of the projecting pin 16. Of course those skilled in the art will realize this engagement could be reversed or other means employed for a pierced engagement and such is anticipated.

To achieve an easy pierced engagement through the pierceable surface 20, it is highly useful if the distal end of the pin 16 which engages in the cavity 18 is shaped to spear through the surface 20 or self-tap through the surface 20 and into the cavity 18. Those skilled in the art will realize that numerous means to engage the base mount 14 to the guide member 12 can be employed to engage the base mount 14 to the guide member 12, and such are anticipated. The device can be sold in individual configurations noted herein and yield a highly customizable component to catch line during a fishing session no mater which is used. Also, if the device is sold in kit form, with multiple mounting means to a surface, suction cups 15 could be provided that would have pin 16 to allow them to engage to the guide member 12 when a suctioned engagement is desirable and base mounts 14 also provided when a pierced mount to a surface is desirable thereby providing great utility. Still further, base mounts 14 with the tongue and groove bottom surface shown in FIG. 11 could also be provided in the kit to yield a third means of engagement to the chosen surface 20. Additionally, a telescopic version of said guide member 12 shown in FIG. 2 could be employed with all embodiments or modes of the device to allow for even more compact storage of the guide members 12 either in a kit or deployed and mounted.

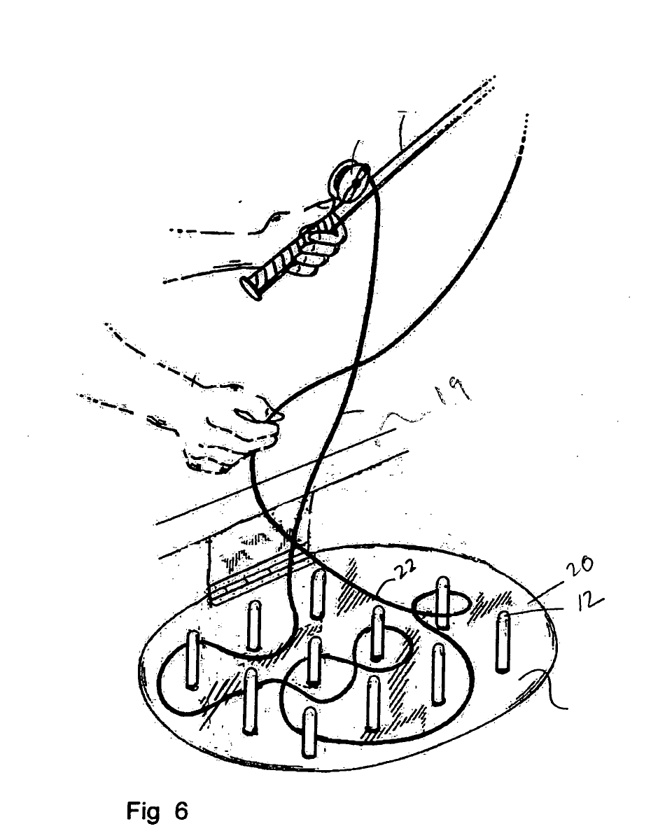

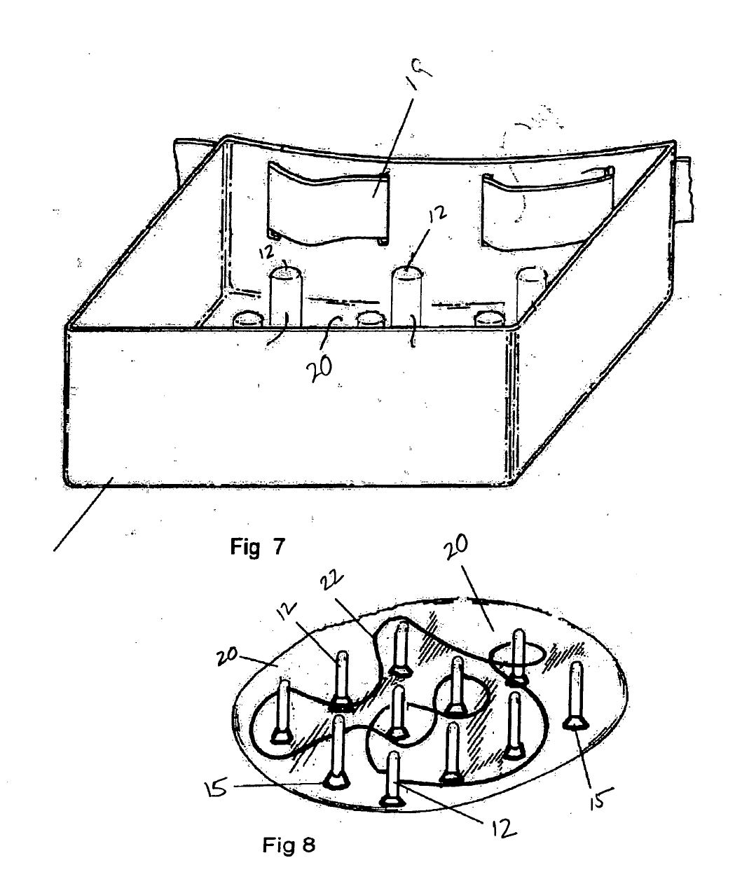

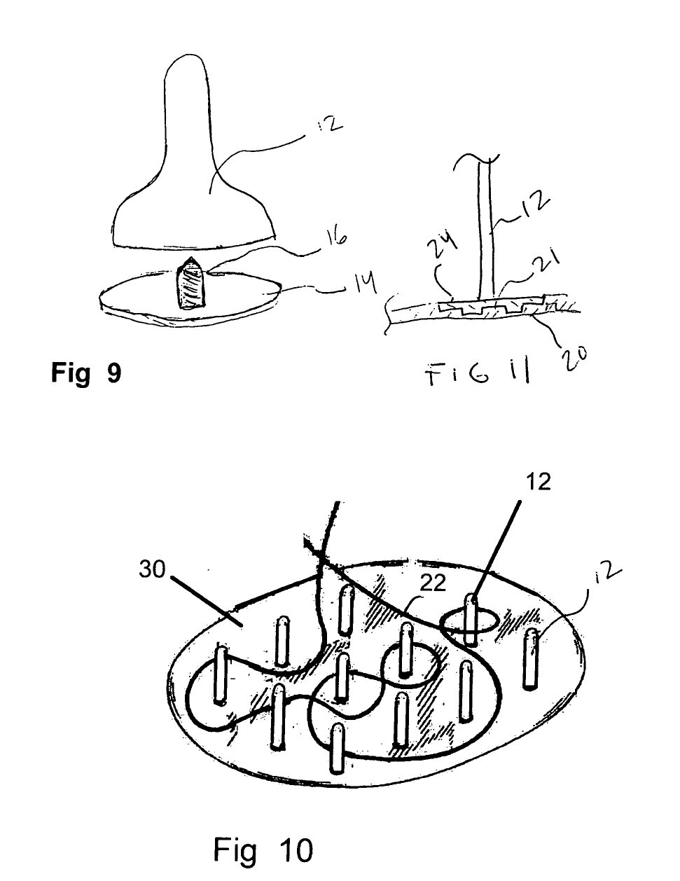

In an operative mount to a surface as depicted in FIGS. 6-7, where the angler can wear the formed device using a belt 19 or other means to engage the device to the user, the guide members 12 are operatively engaged to a pierceable mounting surface 20 by sandwiching that surface 20 in between the guide member 12 and the base mount 14. A hole is formed in the mounting surface 20 to allow for this engagement. The hole can be formed with a tool, or the pin 16 may be pointed as shown in FIG. 9, or otherwise formed to provide a means for piercing of the surface 20 to allow for engagement with the guide member 12. A sandwiched engagement with the surface 20 is thereby achieved with the guide members 12 extending substantially perpendicular from the top of the surface 20 to provide a customizable pathways between the guide members 12 as a guide for the line 22 to prevent tangling during stripping.

If an especially sturdy mount is desired for the guide member 12, a mating base component 24 may optionally be attached to the base end of the guide member 12 and provide additional vertical support to the guide member 12 when the base 14 is operatively engaged as shown in FIG. 3.

In cases where a basket or angler-mounted planar surface is not employed by the angler and the device is formed to be used on the ground adjacent to the user, the device 10 may be formed on the ground or any smooth surface adjacent to the angler such as a boat deck by employing that smooth surface as the actual mounting surface 20. As shown in FIG. 5, the base mount 14 for the guide members 12 would be a suction cup 15 which is easily engaged to a smooth surface using the appropriate compression to achieve suctional engagement. The user determined serpentine pathways for the stripped line is thereby formed between the plurality of guide members 12 which are suction mounted to the boat deck or other smooth surface forming the mounting surface 20. This is best shown in FIG. 8 which depicts a plurality of guide members 12 suction mounted to a boat deck providing the mounting surface 20. However, a smooth mat or other smooth surface might also be employed if the user were to form pathways on a mounting surface 20 for use on land which is not pierced.

The simplest form of an angler-worn line catcher to which the device 10 can be mounted is shown in FIG. 6 which depicts a plurality of guide members 12 extending from a substantially rigid planar mounting surface 20 and engaged with base mounts 14 on the bottom end of the mounting surface 20. A plurality of user determined serpentine pathways for the line 22 are thereby formed in-between the plurality of guide members 12.

In FIG. 7 a plurality of the guide members 12 are engaged through the bottom surface 20 of a basket which is angler-worn and employed to hold stripped line 22. A plurality of guide members 12 are engaged with the surface 20 using the aforementioned sandwich style mount of the base 14 to the guide members 14 through apertures formed in the bottom surface 20. This embodiment allows the angler to form the device from any available pierceable basket be it plastic or fabric or woven mesh using a plurality of the provided guide members 12 and base mounts 14 adapted for a pierced engagement.

While the substantially cylindrical shape of the guide members 12 shown in other figures is preferred because the narrow width of the guide members 12 provides for easy storage and packaging, FIG. 9 depicts another embodiment of the removably mountable guide members 12 which is frusto-conical in its exterior shape. The type of shape provides a large base end to the guide member 12 which will provide more support for the guide member 12 when the surface 20 is sandwiched between the base 14 and the guide member 12.

The device 10 in use, provides the user determined serpentine pathway for stripped line 22 on any surface by simply engaging a plurality of the guide members 12 to that surface using the appropriate base mounts 14 for the surface chosen. It can be sold in a kit form with a plurality of guide members 12 engageable with a plurality of different style base members 12 including flat bases or suction cups and threaded or frictional engagement or tongue and groove or other engagement that might occur to those skilled in the art.

FIG. 10 shows another preferred embodiment of the device 10 wherein the guide members 12 are engaged with a flexible surface layer 30 which can be placed on the ground or a boat deck adjacent to an angler. The surface layer 30 might be rigid material if the device is to go on the ground, or in a particularly preferred embodiment the surface layer 30 is made of flexible material such as silicone or neoprene or similar mat material which tends to removably adhere to a boat deck or other surface. Making the surface layer 30 flexible allows it to adapt to uneven or curved support surfaces.

FIG. 11 depicts another mode of the device 10 allowing for a very high degree of customization. In this mode, the textured top surface 21 of the mounting surface 20 is shaped to engage a cooperating bottom surface of a mating base component 24 attached to the base end of the guide member. This would give an easy tongue and groove type engagement of all of the plurality of guide members 12 to infinite numbers of points of contact to the top surface. Of course other means of releasable cooperative engagement of the bottom of the base component 24 and the top surface 21 can be used and are anticipated. Further, the device in kit form as noted above can include the base components 24 adapted to engage the base end of the guide member 12 on one side and having the bottom surface shaped to engage to top surface 21 of the mounting surface 20 along with one or more of the other means to engage the mounting surface 20 so the user can use whatever surface is available and then adapt the guide members 12 appropriately to engage it and form a custom configuration for their stripped line 22.

While all of the fundamental characteristics and features of the invention have been shown and described herein, with reference to particular embodiments thereof a latitude of modification, various changes and substitutions are intended in the foregoing disclosure and it will be apparent that in some instance, some features of the invention may be employed without a corresponding use of other features without departing from the scope of the invention as set forth. It should also be understood that various substitutions, modifications and variations may be made by those skilled in the art without departing from the spirit or scope of the invention. Consequently, all such modifications and variations and substitutions are included within the scope of the invention as defined by the following claims.

What is claimed is:

1. A user configurable guide apparatus for stripped fishing line comprising:
a plurality of elongated guide members having a distal end and a base end;
a plurality of base mounts adapted for an engagement with said base end of said guide members;
said respective base mounts in said engagement with said respective base ends, thereby providing means to engage each of said plurality of guide members to a projecting mount from a mounting surface, and forming gaps between said plurality of guide members; and
said gaps providing a serpentine path adapted to receive said fishing line therein and preventing tangles in said fishing line.

2. The guide apparatus of claim 1 wherein said base mounts are adapted for a removable engagement upon a top surface of said mounting surface.

3. The guide apparatus of claim 1 wherein said projecting mount is provided by a sandwiched engagement of said mounting surface between said base mounts and said guide members.

4. The guide apparatus of claim 1 wherein said projecting mount is provided by a suction mount of said base mounts to said mounting surface.

5. The guide apparatus of claim 2 wherein said projecting mount is provided by a suction mount of said base mounts to said top surface.

6. The guide apparatus of claim 5 wherein said top surface is a boat deck.

7. The guide apparatus of claim 5 wherein said top surface is a planar mat.

8. The guide apparatus of claim 2 wherein said base mounts are adapted for a removable engagement upon a top surface of said mounting surface through a frictional engagement of cooperating projections and depressions located on both said top surface and said base mounts.

9. The guide mount apparatus of claim 3 wherein said surface is the bottom surface defined by surrounding sidewalls, of a stripping basket worn by said angler.

10. The guide mount apparatus of claim 4 wherein said surface is the bottom surface defined by surrounding sidewalls, of a stripping basket worn by said angler.

11. The guide mount apparatus of claim 1 wherein said mounting surface is a flexible sheet of material which is positionable upon a supporting surface adjacent to said user.

12. The guide mount apparatus of claim 2 wherein said a plurality of elongated guide members are provided in a kit having a plurality of different configurations of base mount members of said kit;
each of said configurations of base mount members of said kit adapted for engagement to said plurality of guide members;
said members of said kit including one or a combination of base mounts including:
base mounts adapted for suctional engagement to said top surface; and
base mounts adapted for engagement with said guide members with said mounting surface sandwiched therebetween.

13. The guide apparatus of claim 3 wherein sandwiched engagement of said mounting surface between said base mounts and said guide members also includes:
a projection from said base mount adapted to engage within an axial cavity in said guide member.

14. The guide apparatus of claim 13 additionally comprising:
means to pierce said mounting surface located on a distal end of said projection; and
whereby said mounting surface may be pierced and said projection engaged with said axial cavity to achieve said sandwiched engagement.

15. The guide apparatus of claim 12 additionally comprising:
said base mounts adapted for suctional enagmennt having a suction cup; and
base mounts adapted for engagement with said guide members with said mounting surface sandwiched therebetween having a projection from said base mount adapted to engage within an axial cavity in said guide member and having means to pierce said mounting surface located on a distal end of said projection.

16. The guide apparatus of claim 1 additionally comprising:
said guide members being telescopic.
